(19) United States
(12) Patent Application Publication
(10) Pub. No.: US 2024/0039195 A1
(43) Pub. Date: Feb. 1, 2024

(54) CONNECTOR AND CONNECTOR ASSEMBLY

(71) Applicant: Yamaichi Electronics Co., Ltd., Tokyo (JP)

(72) Inventor: Toshiyasu ITO, Tokyo (JP)

(21) Appl. No.: 18/227,508

(22) Filed: Jul. 28, 2023

(30) Foreign Application Priority Data
Jul. 29, 2022 (CN) 202210909231.9

(51) Int. Cl. H01R 12/72; H01R 13/6471; H01R 43/20; H01R 13/05

(52) U.S. Cl. CPC H01R 12/724; H01R 12/721; H01R 13/6471; H01R 12/727; H01R 43/20; H01R 13/05

(57) ABSTRACT

Provided are a connector and a connector assembly that can reduce an insertion loss. A connector is configured such that a substrate is inserted along an insertion-extraction direction in a region between a first pin group and a second pin group. The contact pins each have: a curved part, curved convex toward the region and including a contact point contacted with an electrode pad of the substrate; and a straight first beam part, having a tip which is connected to a base end of the curved part, and a base end which is bent so as to be spaced away from the region.

### CROSS-REFERENCE TO RELATED APPLICATIONS

This application claims foreign priority benefits under U.S.C. § 119 to Chinese Patent Application No. 202210909231.9 filed on Jul. 29, 2022, the contents of which is hereby incorporated by reference in its entirety.

### TECHNICAL FIELD

The present invention relates to a connector and a connector assembly.

### BACKGROUND ART

For example, Patent Literature 1 discloses a receptacle assembly having a first receptacle conductor array and a second receptacle conductor array that are vertically arranged and a plug assembly having a first plug conductor array and a second plug conductor array that are vertically arranged.

Further, these assemblies take a configuration such that the plug assembly is fitted into the receptacle assembly and thereby each conductor of the plug assembly comes into contact with each conductor of the receptacle assembly.

### CITATION LIST

### Patent Literature

[PTL 1]
U.S. Pat. No. 9,531,129

### SUMMARY OF INVENTION

### Technical Problem

Although being different from the configuration disclosed in Patent Literature 1, a configuration in which contact pins 321, 331 (conductors) have curved parts 321a, 331a and linear spring beam parts 321c, 331c connected to base ends of the curved parts 321a, 331a as illustrated in FIG. 18 and FIG. 19 is discussed here, for example. When a device (a substrate 421 in FIG. 18 and FIG. 19) is inserted, the contact points between the curved parts 321a, 331a and the substrate 421 serve as the points of effort, a portion on the tip side from fixing parts between a housing and the contact pins 321, 331 is elastically deformed, thereby the spacing between the upper contact pin 321 and the lower contact pin 331 increases, and the contact pins come into contact with the electrode pads 421a of the substrate 421 at contact points located in the curved parts 321a, 331a.

In this state, as illustrated in FIG. 20, the position of contact point may be shifted due to a tolerance of each component forming a connector (a manufacturing tolerance of the connector), a manufacturing tolerance of the substrate 421, or a fitting tolerance of both components. Note that, in FIG. 20, only the contact pin 321 is illustrated.

Herein, if the dimension of each component or each part of the connector or the substrate 421 is designed without taking the manufacturing tolerance of the connector, the manufacturing tolerance of the substrate 421, or the fitting tolerance of both the components into consideration, the contact pin 321 may be out of contact with the electrode pad 421a (see a portion surrounded by a circle illustrated in the lower diagram in FIG. 20).

Thus, as illustrated in FIG. 20, to prevent occurrence of the contact pin 321 that is out of contact with the electrode pad 421a, in general, the manufacturing tolerance of the connector, the manufacturing tolerance of the substrate 421, and the fitting tolerance of both the components are taken into consideration, and the dimension of each component or each part of the connector or the substrate 421 is then designed so that all the contact pins 321, 331 are reliably in contact with the electrode pads 421a after insertion of the substrate 421.

In such a situation, if the design is made in accordance with the concept described above in order to reliably cause all the contact pins 321, 331 to come into contact with the electrode pads 421a, the length dimension of the electrode pad 421a becomes longer than that when the tolerances are not taken into consideration.

Herein, when the end of the electrode pad 421a is denoted as a tip 421a2, the range from the contact point between the contact pin 321 and the electrode pad 421a to the tip 421a2 of the electrode pad 421a is referred to as “Stub”, and the length dimension thereof is referred to as “fitting length”.

With a longer length dimension of the electrode pad 421a, however, signal degradation will occur, because a part of a signal S transmitted from the contact point to the electrode pad 421a flows on the tip 421a2 side of the electrode pad 421a, is reflected at the free end of the tip 421a2, and returns to the contact point. Further, when a high-frequency signal S is intended to be transmitted in order to achieve a transmission rate of 200 Gbps or higher, for example, occurrence of signal degradation due to influence of Stub as described above will cause an insertion loss. In particular, a longer fitting length will cause a more significant insertion loss.

Nevertheless, if the fitting length is designed shorter in order to suppress influence of signal degradation due to the reciprocal phenomenon of the signal S, a likelihood of the contact pin 321 failing to come into contact with the electrode pad 421a will increase as described above.

Accordingly, the present invention intends to provide a connector and a connector assembly that can reduce an insertion loss.

### Solution to Problem

To solve the problem described above, the connector and the connector assembly of the present invention employ the following solutions.

That is, a connector according to the first aspect of the present invention includes: a first pin group having a plurality of contact pins aligned in a predetermined direction; and a second pin group having a plurality of contact pins aligned in the predetermined direction and arranged so as to face the first pin group, and a device is inserted and extracted along an insertion-extraction direction in and from a region between the first pin group and the second pin group. Each of the contact pins has a curved part curved convex toward the region and including a contact point contacted with an electrode of the device, and a straight first beam part having a tip and a base end, the tip of the first beam part being connected to a base end of the curved part, and the base end of the first beam part being bent so as to be spaced away from the region.

According to the connector of the present aspect, each contact pin has a straight first beam part having a tip, which is connected to a base end of the curved part, and a base end, which is bent so as to be spaced away from the region. Thus, for example, the first beam part can be located closer to the electrode than a portion connected to the base end side of the first beam part.

Accordingly, since a high-frequency signal (for example, a signal at a frequency of 60 GHz or higher) is directly transmitted from the first beam part to the electrode without routed via the contact point, the insertion loss caused by signal degradation due to the fitting length (Stub) can be reduced. In other words, since the signal can be transmitted directly from the first beam part to the electrode by the effect described above, a long fitting length can be ensured to eliminate influence of tolerances.

Further, in the connector according to the second aspect of the present disclosure, each of the contact pins has a second beam part having a tip and a base end, the tip of the second beam part being connected to the base end of the first beam part, and the base end of the second beam part serving as a fixed end for elastic deformation, and the first beam part has a smaller inclination angle relative to the insertion-extraction direction than the second beam part, in the first aspect.

According to the connector of the present aspect, each contact pin has a curved part curved convex and including a contact point with an electrode of the device, a straight first beam part having a tip, which is connected to a base end of the curved part, and a second beam part having a tip, which is connected to the base end of the first beam part, and a base end, which serves as a fixed end for elastic deformation, and the first beam part has a smaller inclination angle relative to the insertion-extraction direction than the second beam part. Thus, when the device has been inserted, the angle of the first beam part relative to the electrode of the device can be smaller than the angle of the second beam part relative to the electrode of the device.

Thus, the contact pin can be located closer to the electrode by the first beam part compared to a conventional configuration without the first beam part.

Accordingly, since a high-frequency signal (for example, a signal at a frequency of 60 GHz or higher) is directly transmitted from the first beam part to the electrode without routed via the contact point, the insertion loss caused by signal degradation due to the fitting length (Stub) can be reduced. In other words, since the signal can be transmitted directly from the first beam part to the electrode by the effect described above, a long fitting length can be ensured to eliminate influence of tolerances.

Further, in the connector according to the third aspect of the present invention, the first beam part has an angle relative to the electrode that is greater than or equal to −10 degrees and less than or equal to 10 degrees with the device inserted, in the first aspect or the second aspect.

According to the connector of the present aspect, since the first beam part has an angle relative to the electrode is greater than or equal to −10 degrees and less than or equal to 10 degrees with the device inserted, the first beam part can be located close to the electrode.

Further, in the connector according to the fourth aspect of the present invention, the first beam part is substantially parallel to the electrode with the device inserted, in any one of the first aspect to the third aspect.

According to the connector of the present aspect, since the first beam part is substantially parallel to the electrode with the device inserted, the first beam part can be located close to the electrode more evenly.

Further, in the connector according to the fifth aspect of the present invention, the first beam part has a length dimension such that, with the device inserted, a tip of the electrode is located between the base end of the first beam part and the tip of the first beam part in the insertion-extraction direction, in any one of the first aspect to the fourth aspect.

According to the connector of the present aspect, since the first beam part has a length dimension such that, with the device inserted, the tip of the electrode is located between the base end of the first beam part and the tip of the first beam part in the insertion-extraction direction, the tip of the electrode is covered with the first beam part, and a signal reciprocal phenomenon can be more reliably avoided.

Further, in the connector according to the sixth aspect of the present invention, a distance from the first beam part to the electrode is less than or equal to 0.07 mm with the device inserted, in any one of the first aspect to the fifth aspect.

According to the connector of the present aspect, since the distance from the first beam part to the electrode is less than or equal to 0.07 mm with the device inserted, a high-frequency signal can be efficiently, directly transmitted from the first beam part to the electrode.

Further, in the connector according to the seventh aspect of the present invention, a distance from the first beam part to the electrode is greater than or equal to 0.03 mm with the device inserted, in the sixth aspect.

According to the connector of the present aspect, since the distance from the first beam part to the electrode is greater than or equal to 0.03 mm with the device inserted, the insertion loss can be suppressed as much as possible within a range where the first beam part is not in direct contact with the electrode.

Further, a connector according to the eighth aspect of the present invention includes: a first pin group having a plurality of contact pins aligned in a predetermined direction; and a second pin group having a plurality of contact pins aligned in the predetermined direction and arranged so as to face the first pin group, and a device is inserted along an insertion-extraction direction in a region between the first pin group and the second pin group. Each of the contact pins has a curved part curved convex toward the region and including a contact point contacted with an electrode of the device, a straight first beam part having a tip connected to a base end of the curved part, and a second beam part having a tip and a base end, the tip of the second beam part being connected to the base end of the first beam part, and the base end of the second beam part serving as a fixed end for elastic deformation, and the first beam part of each of the contact pins of the first pin group and the first beam part of each of the contact pins of the second pin group are substantially parallel to each other with the device inserted.

Further, the connector according to the ninth aspect of the present invention includes a conductive member contacted with a ground pin for grounding out of the contact pins of the first pin group and to a ground pin for grounding out of the contact pins of the second pin group, in any one of the first aspect to the eighth aspect.

According to the connector of the present aspect, since the connector includes a conductive member contacted with a ground pin for grounding out of the contact pins of the first pin group and to a ground pin for grounding out of the contact pins of the second pin group, noise can be attenuated by the conductive member.

Further, the connector according to the tenth aspect of the present invention includes a plurality of contact pins, a signal is transmitted from a base end to a tip of each of the contact pins, and a device having an electrode is inserted in the connector. Each of the contact pins has a contact point and a first beam part, the contact point being contacted with the electrode, and the first beam part being electrically connected to the electrode in a contactless manner on the base end side from the contact point.

Further, a connector assembly according to the eleventh aspect of the present invention includes: the connector according to any one of the first aspect to the tenth aspect; and the device inserted in the connector.

### Advantageous Effects of Invention

According to the present invention, the insertion loss can be reduced.

### BRIEF DESCRIPTION OF DRAWINGS

FIG. 1 is a perspective view of a connector according to one embodiment of the present disclosure.

FIG. 2 is a perspective view of the connector (with a substrate inserted) according to one embodiment of the present disclosure.

FIG. 3 is a perspective view of the connector in which a housing is omitted in FIG. 2.

FIG. 4 is a sectional view taken along a cut line IV-IV illustrated in FIG. 1.

FIG. 5 is a sectional view taken along a cut line V-V illustrated in FIG. 2.

FIG. 6 is a side view of a contact pin.

FIG. 7 is a partial enlarged view of FIG. 5.

FIG. 8 is a partial enlarged view of FIG. 7.

FIG. 9 is a perspective view of contact pins in contact with the substrate.

FIG. 10 is a perspective view of the contact pins in which a single contact pin for signal transmission is omitted in FIG. 9.

FIG. 11 is a graph illustrating a relationship between the frequency and the insertion loss (clearance is 0.03 mm).

FIG. 12 is a graph illustrating a relationship between the frequency and the insertion loss (clearance is 0.05 mm).

FIG. 13 is a graph illustrating a relationship between the frequency and the insertion loss (clearance is 0.07 mm).

FIG. 14 is a graph illustrating a relationship between the frequency and the insertion loss (clearance is 0.10 mm).

FIG. 15 is a graph illustrating a relationship between the frequency and the insertion loss as a comparative example.

FIG. 16 is a side view of the contact pin according to a modified example to one embodiment of the present disclosure.

FIG. 17 is a side view of the contact pin according to a modified example to one embodiment of the present disclosure.

FIG. 18 is side view of contact pins as a comparative example.

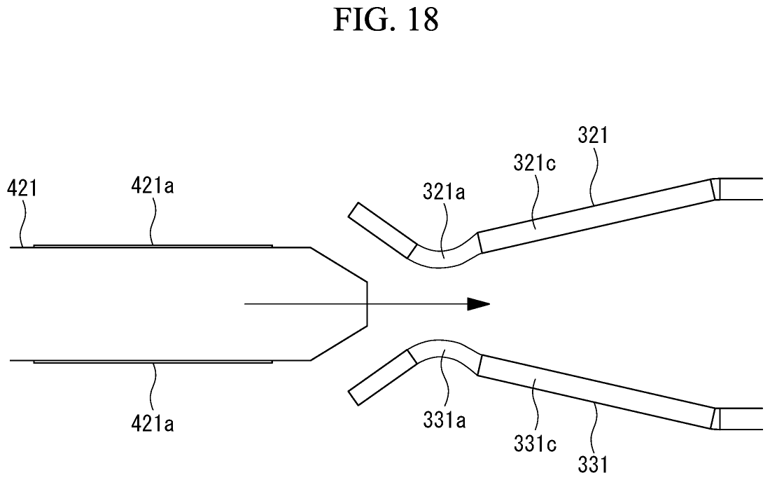

FIG. 19 is side view of the contact pins (with a substrate inserted) as the comparative example.

FIG. 20 is a diagram illustrating a position shift of the contact pin as the comparative example.

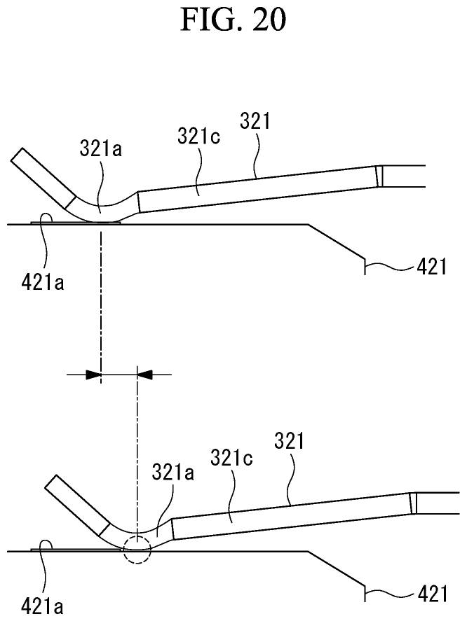

FIG. 21 is a diagram illustrating a signal reciprocal phenomenon in the contact pin as the comparative example.

### DESCRIPTION OF EMBODIMENTS

A connector and a connector assembly according to one embodiment of the present invention will be described below with reference to the drawings.

### Overview of Connector

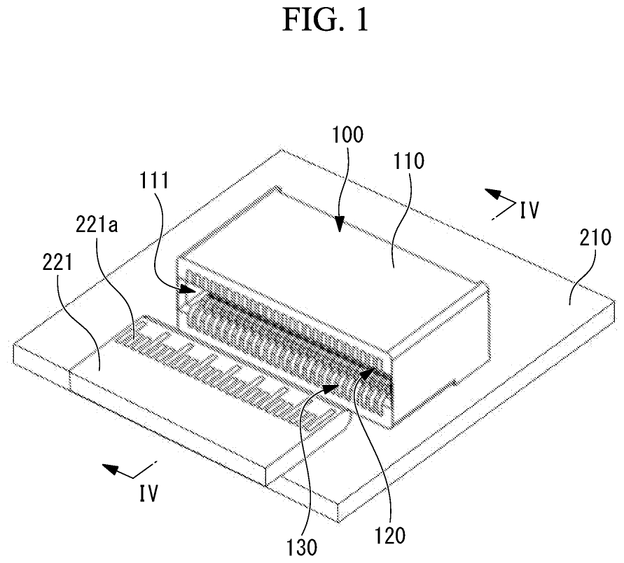

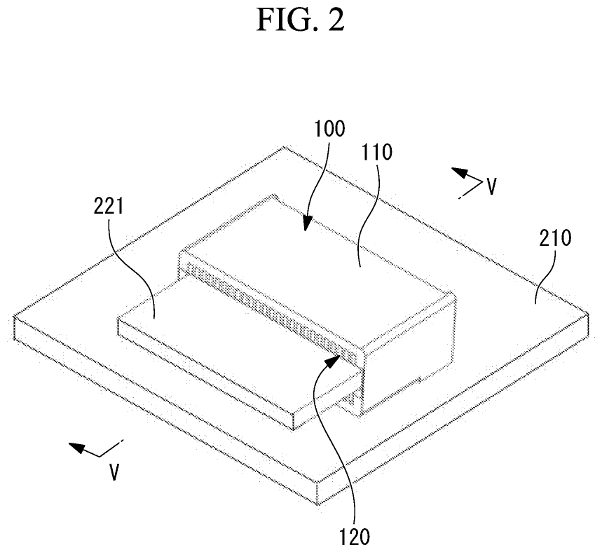

As illustrated in FIG. 1 and FIG. 2, a connector 100 is a connector that is mounted on a mount substrate 210 and in which a device is inserted, that is, a connector that electrically connects the mount substrate 210 and the device to each other.

The device may be, for example, a substrate 221 having electrode pads 221a (electrodes) or a plug connector having contact pins (electrodes).

In the case of FIG. 1 and FIG. 2, the substrate 221 is illustrated as an example, and description will be provided below in the context of the substrate 221 being inserted in the connector 100.

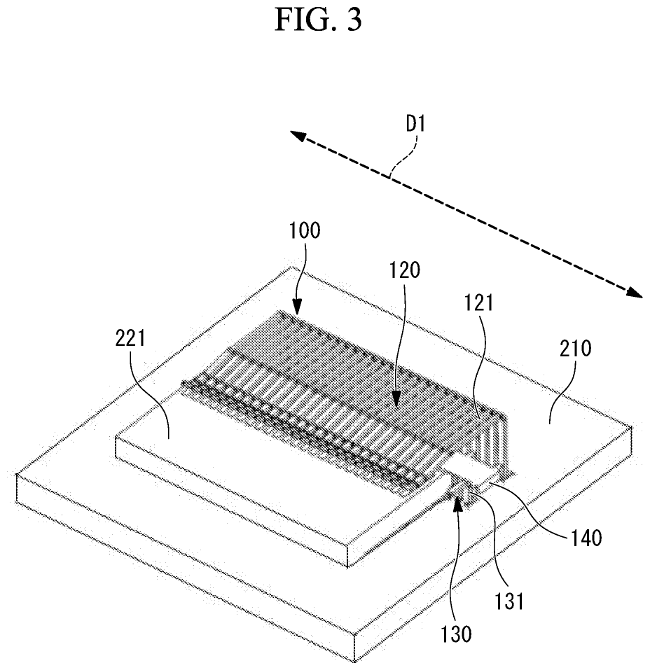

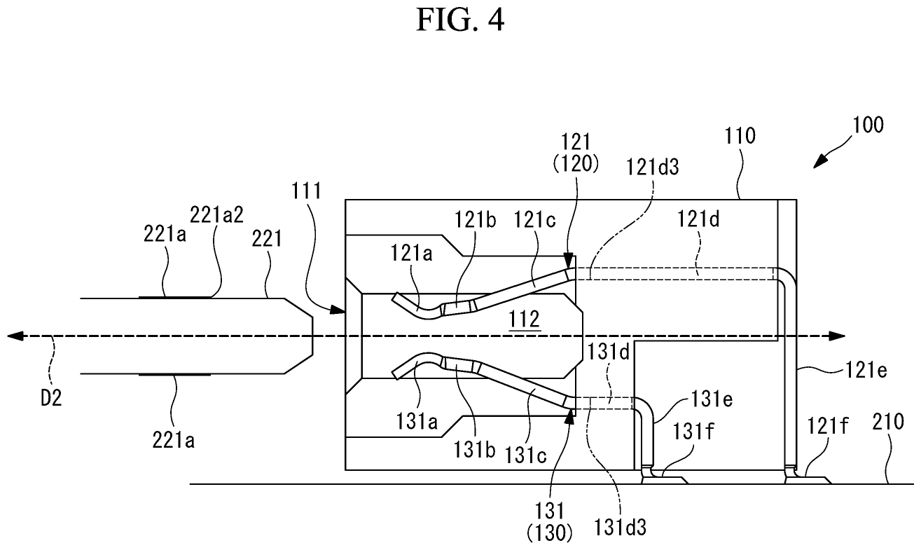

As illustrated in FIG. 1, FIG. 3, and FIG. 4, the connector 100 has a housing 110, a top pin group 120 (first pin group), a bottom pin group 130 (second pin group), and a conductive member 140.

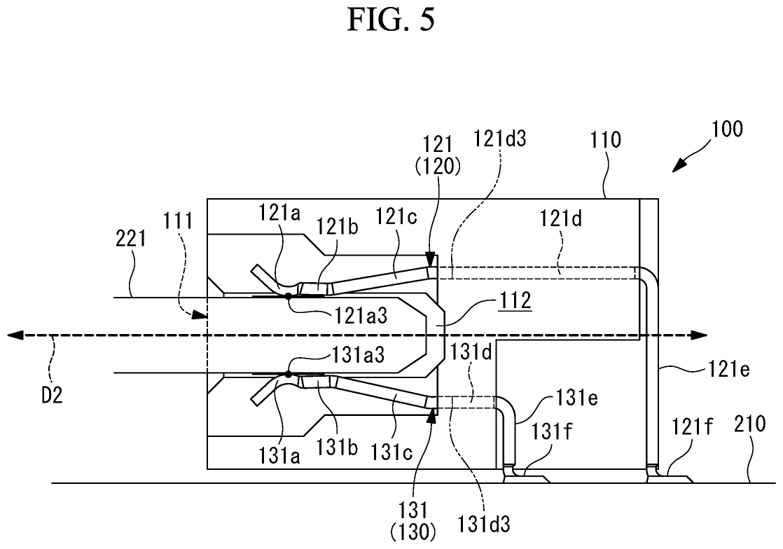

As illustrated in FIG. 1, FIG. 4, and FIG. 5, the housing 110 is a component having substantially a rectangular parallelepiped external shape and accommodates and holds the top pin group 120, the bottom pin group 130, and the conductive member 140.

The housing 110 is a nonconductive member and is molded from a resin or the like, for example.

A front opening 111 communicating with an insertion space 112 defined inside the housing 110 is opened in the front face of the housing 110.

The front end side of the substrate 221 is inserted in the insertion space 112 via the front opening 111.

As illustrated in FIG. 3, the top pin group 120 is configured with a plurality of contact pins 121 being aligned in a predetermined direction D1.

As illustrated in FIG. 1, the alignment direction of the contact pins 121 in the top pin group 120 matches the longitudinal direction of the housing 110.

The contact pins 121 serve as signal pins for signal transmission or ground pins for grounding and are aligned in accordance with a predetermined rule. Note that pins having other purposes than the above may be provided.

The contact pin 121 is an elongated metal terminal for electrical conduction and has a curved part 121a, a parallel beam part 121b (first beam part), a spring beam part 121c (second beam part), a substantially-straight part 121d, an erect part 121e, and a mount part 121f in this order from the tip side to the base end side.

The detailed configuration of these parts will be described later.

As illustrated in FIG. 3, the bottom pin group 130 is configured with a plurality of contact pins 131 being aligned in the predetermined direction D1.

As illustrated in FIG. 1, the alignment direction of the contact pins 131 in the bottom pin group 130 matches the longitudinal direction of the housing 110.

The contact pins 131 serve as signal pins for signal transmission or ground pins for grounding and are aligned in accordance with a predetermined rule. Note that pins having other purposes than the above may be provided.

The contact pin 131 is an elongated metal terminal for electrical conduction and has a curved part 131a, a parallel beam part 131b (first beam part), a spring beam part 131c (second beam part), a substantially-straight part 131d, an erect part 131e, and a mount part 131f in this order from the tip side to the base end side.

The detailed configuration of these parts will be described later.

As illustrated in FIG. 3 to FIG. 5, in a state where the top pin group 120 and the bottom pin group 130 are assembled in the housing 110 and the connector 100 is mounted on the mount substrate 210, the top pin group 120 (in detail, a portion on the tip side from the substantially-straight part 121d) is arranged so as to face the bottom pin group 130 (in detail, a portion on the tip side from the substantially-straight part 131d) in the insertion space 112.

As illustrated in FIG. 4 and FIG. 5, the substrate 221 is inserted in an insertion-extraction direction D2 via the front opening 111 in a region between the top pin group 120 and the bottom pin group 130 arranged facing each other. Each contact pin 121 and each contact pin 131 then come into contact with the electrode pads 221a of the substrate 221. Herein, the insertion-extraction direction D2 of the substrate 221 is in the horizontal direction, for example.

As illustrated in FIG. 3, the conductive member 140 is accommodated in the housing 110 in a state electrically connected to predetermined contact pins 121 (in detail, respective ground pins) of the top pin group 120 and predetermined contact pins 131 (in detail, respective ground pins) of the bottom pin group 130.

Note that the “state electrically connected” is, for example, a state where the conductive member 140 is in physical contact with respective ground pins or a state where the conductive member 140 is provided with a slight clearance to respective ground pins. The “slight clearance” as used herein is a clearance of a spacing having a distance between which a high frequency field of 1 GHz or higher can be electrically connected and, for example, ranges from 0.05 mm to 0.1 mm.

The conductive member 140 is a member having predetermined conductivity and is molded from a resin in which conductive particles are dispersed, an antistatic resin, or the like, for example. For example, the “predetermined conductivity” as used herein is greater than or equal to 10 S/m and less than or equal to 200 S/m and, preferably, greater than or equal to 30 S/m and less than or equal to 150 S/m.

Because the conductive member 140 is installed, noise can be attenuated.

### Detail of Contact Pin 121

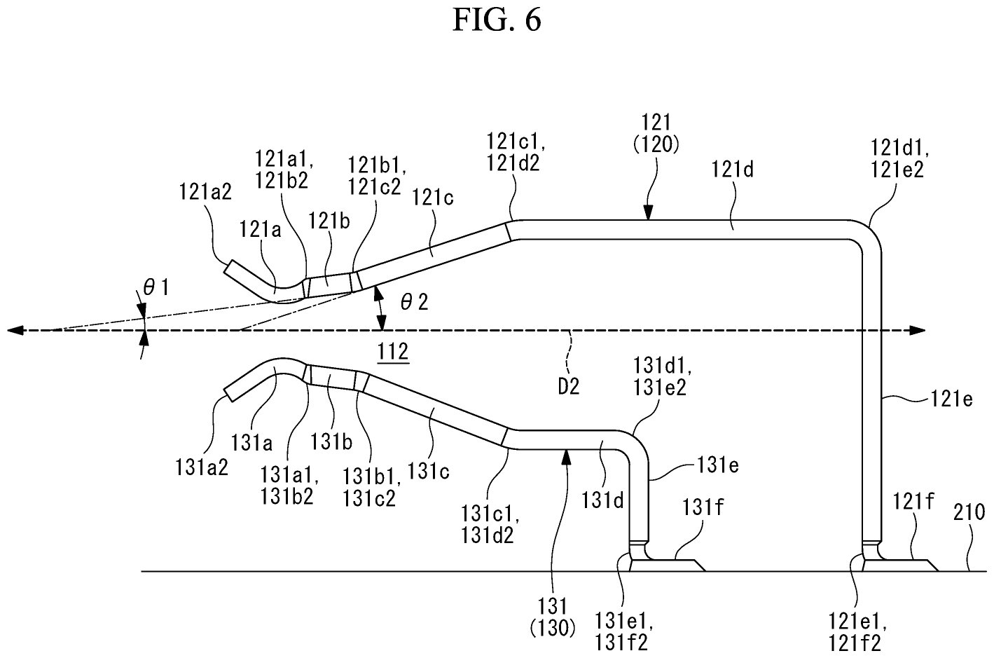

As described above, each contact pin 121 has the curved part 121a, the parallel beam part 121b (first beam part), the spring beam part 121c (second beam part), the substantially-straight part 121d, the erect part 121e, and the mount part 121f in this order from the tip (the left end of FIG. 6) side to the base end (the right end of FIG. 6) side, as illustrated in FIG. 6.

As illustrated in FIG. 6 to FIG. 8, the curved part 121a is a portion curved convex inward. Note that “inward” as used herein means a direction facing the contact pin 131 or a direction facing the region in which the substrate 221 is inserted, for example.

The curved part 121a is a portion in the contact pin 121 forming a contact point with the electrode pad 221a of the substrate 221.

The parallel beam part 121b is a straight portion having the tip 121b2 connected to the base end 121a1 of the curved part 121a.

When the substrate 221 is not inserted, the parallel beam part 121b is inclined by an angle θ1 relative to the insertion-extraction direction D2.

When the substrate 221 is not inserted, the angle θ1 is larger than 0 degree.

The base end 121b1 of the parallel beam part 121b forms a bent part bent outward.

Note that “outward” as used herein means a direction facing away from the contact pin 131 or a direction facing away from a region in which the substrate 221 is inserted, for example.

The spring beam part 121c is a straight portion having the tip 121c2 connected to the base end 121b1 of the parallel beam part 121b.

Herein, the base end 121b1 of the parallel beam part 121b connected to the tip 121c2 of the spring beam part 121c is bent outward as described above. Further, a part of the parallel beam part 121b from the tip 121b2 to the base end 121a1 side of the curved part 121a is bent inward. Thus, the parallel beam part 121b is located close to the electrode pad 221a with a smaller inclination than the spring beam part 121c inside the spring beam part 121c.

When the substrate 221 is not inserted, the spring beam part 121c is inclined by an angle θ2 relative to the insertion-extraction direction D2. The angle θ2 is larger than the angle θ1. In other words, the parallel beam part 121b is less inclined than the spring beam part 121c relative to the insertion-extraction direction D2.

The substantially-straight part 121d is a straight portion having the tip 121d2 connected to the base end 121c1 of the spring beam part 121c.

The substantially-straight part 121d extends in the insertion-extraction direction D2.

In the substantially-straight part 121d, a portion secured and connected to the housing 110 (hereafter, referred to as “fixed part 121d3”) is present, and the fixed part 121d3 serves as a starting point at which the contact pin 121 is displaced when the substrate 221 is inserted (see FIG. 5).

In other words, when the substrate 221 is inserted, the fixed part 121d3 of the substantially-straight part 121d serves as a stationary end, and a series of a part of the substantially-straight part 121d, the spring beam part 121c, the parallel beam part 121b, and the curved part 121a of the contact pin 121 is elastically deformed, which causes a portion on the tip side from the fixed part 121d3 to be displaced so as to follow the external shape of the substrate 221. At this time, the curved part 121a (in detail, the contact point with the electrode pad 221a) corresponds to the point of effort in the elastic deformation.

In the following, a portion or a range of the contact pin 121 from the stationary end (the fixed part 121d3 of the substantially-straight part 121d) to the point of effort (the contact point between the curved part 121a and the electrode pad 221a) may be denoted as “elastically deforming portion”. The same applies to the contact pin 131.

Note that, in a state where the contact pin 121 is assembled to the housing 110, a portion of the substantially-straight part 121d on the erect part 121e side from the fixed part 121d3 (a portion not included in the elastically deforming portion) is held in the housing 110. Thus, even when the substrate 221 is inserted, this portion of the substantially-straight part 121d is not displaced (not elastically deformed).

The erect part 121e is a straight portion having the tip 121e2 connected at substantially a right angle to the base end 121d1 of the substantially-straight part 121d.

The mount part 121f is a straight portion having the tip 121f2 connected at substantially a right angle to the base end 121e1 of the erect part 121e.

The mount part 121f is a portion mounted on the mount substrate 210.

The contact pin 131 has basically the same configuration as the contact pin 121.

However, the contact pin 131 differs in that the spring beam part 131c, the parallel beam part 131b, and the curved part 131a are inversed in the insertion-extraction direction D2, that the substantially-straight part 131d is shorter than the substantially-straight part 121d, that the erect part 131e is shorter than the erect part 121e, that the mount part 131f is located on the front side from the mount part 121f, and the like.

Note that, in the contact pin 121, it is preferable to provide smooth connection between the base end 121a1 and the tip 121b2, between the base end 121b1 and the tip 121c2, between the base end 121c1 and the tip 121d2, between the base end 121d1 and the tip 121e2, and between the base end 121e1 and the tip 121f2.

The same applies to each base end and each tip of the contact pin 131.

The contact pin 121 and the contact pin 131 configured as described above come into contact with the electrode pads 221a of the substrate 221 as follows, for example.

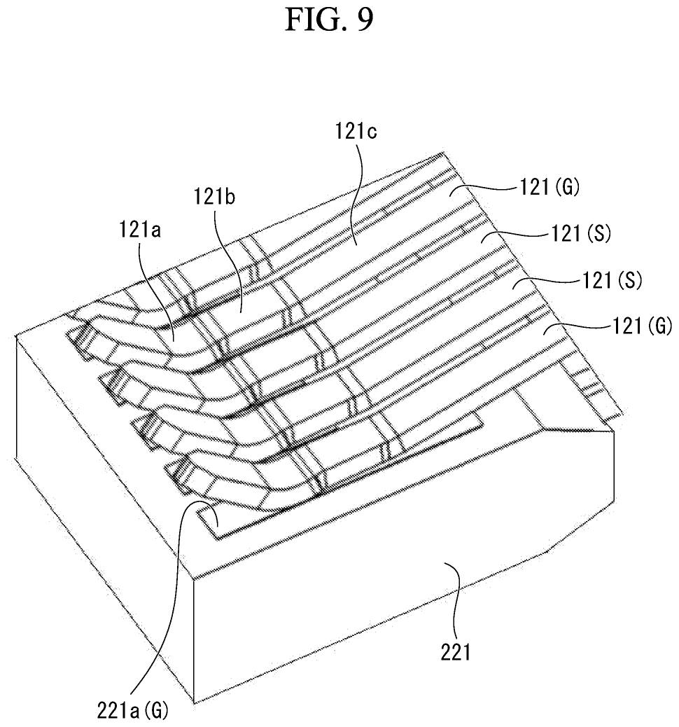

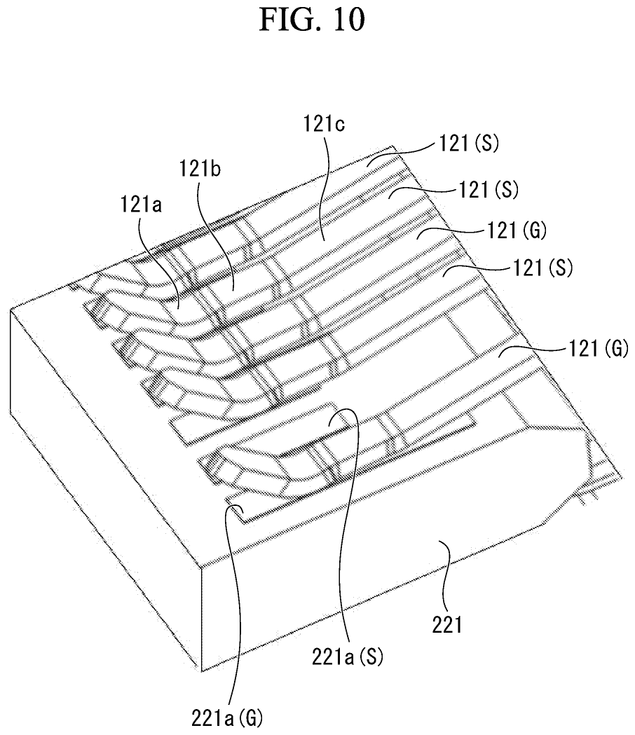

That is, as illustrated in FIG. 4, FIG. 5, FIG. 9, and FIG. 10, when the substrate 221 has been inserted in the connector 100, the contact pin 121 (in detail, the elastically deforming portion of the contact pin 121) and the contact pin 131 (in detail, the elastically deforming portion of the contact pin 131) are elastically deformed, thereby the spacing between the contact pin 121 and the contact pin 131 increases, and the curved part 121a and the curved part 131a come into contact with the electrode pads 221a located on both sides of the substrate 221.

Herein, the point of the curved part 121a contacted with the electrode pad 221a is denoted as a contact point 121a3, and the point of the curved part 131a contacted with the electrode pad 221a is denoted as a contact point 131a3.

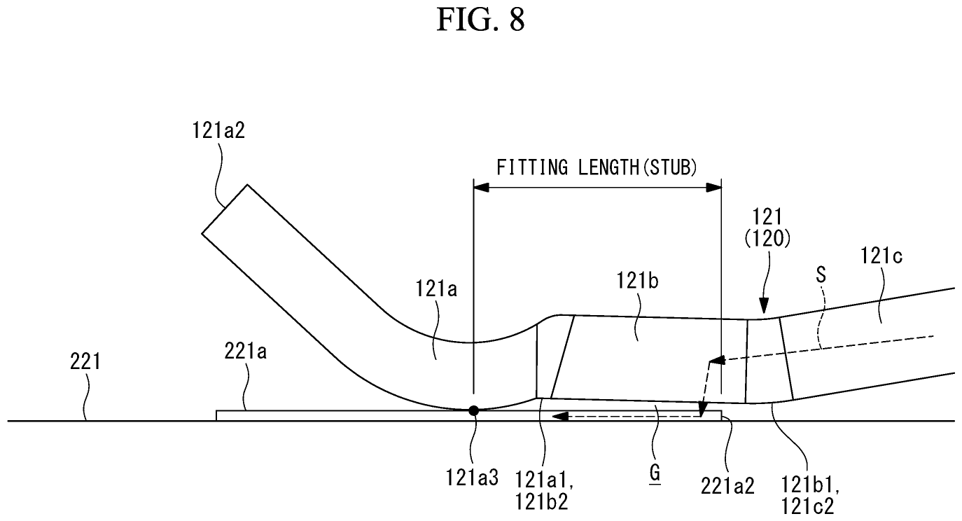

Further, the range from the contact point 121a3/the contact point 131a3 to the tip 221a2 of the electrode pad 221a is referred to as “Stub”, and the length dimension thereof is referred to as “fitting length” (see FIG. 8).

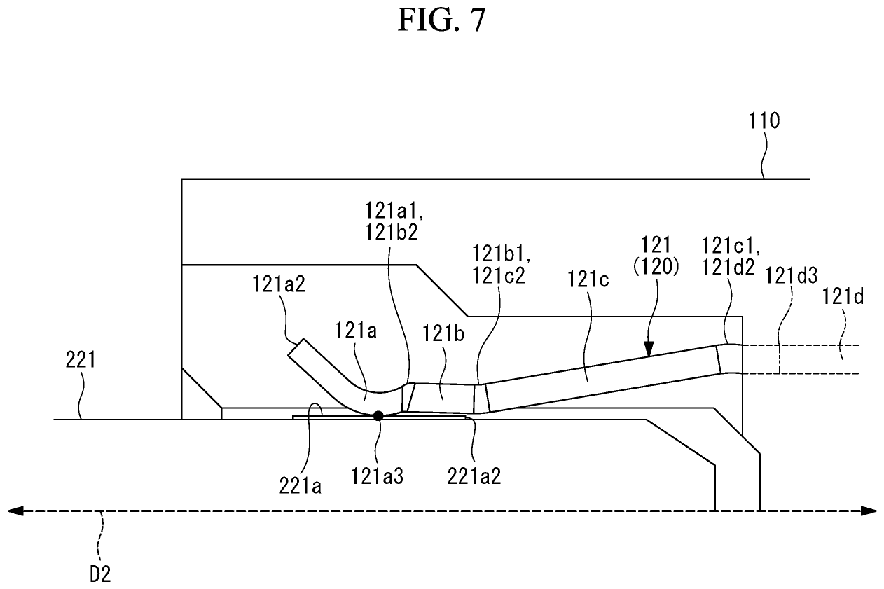

In this state, as illustrated in FIG. 7 and FIG. 8, because the parallel beam part 121b is provided between the spring beam part 121c and the curved part 121a, it is possible to arrange the parallel beam part 121b at a smaller inclination angle than the spring beam part 121c relative to the electrode pad 221a when the substrate 221 has been inserted in the connector 100.

It is preferable that this inclination angle be an angle such that the parallel beam part 121b is substantially parallel to the electrode pad 221a. In other words, the angle θ1 of the parallel beam part 121b is designed to an angle such that the parallel beam part 121b is substantially parallel to the electrode pad 221a in a state where the substrate 221 is inserted in the connector 100.

For example, “substantially parallel” as used herein means being greater than or equal to −10 degrees and less than or equal to 10 degrees, preferably, greater than or equal to −5 degrees and less than or equal to 5 degrees relative to the insertion-extraction direction D2.

With the parallel beam part 121b being arranged substantially parallel to the electrode pad 221a, the clearance G between the parallel beam part 121b and the electrode pad 221a (see FIG. 8) can be reduced.

The reduced clearance G increases the electrostatic capacity, and charges are likely to be accumulated therein. In such a state, for example, when a high-frequency signal S at 60 GHz or higher is transmitted, the signal S is directly transmitted to the electrode pad 221a without routed via the contact point 121a3. That is, the signal S can be transmitted with the parallel beam part 121b and the electrode pad 221a being electrically connected to each other in a contactless state.

Accordingly, the signal S can be transmitted to the electrode pad 221a in upstream of the contact point 121a3 (at a position close to the tip 221a2), and the reciprocal phenomenon of the signal S can be avoided.

Herein, the dimension in the height direction of the clearance G (the thickness direction of the parallel beam part 121b) is preferably greater than or equal to 0.03 mm and less than or equal to 0.07 mm in terms of facilitating transmission of the signal S or suppressing the insertion loss.

Further, it is preferable that the tip 221a2 of the electrode pad 221a be located between the base end 121b1 and the tip 121b2 of the parallel beam part 121b in the insertion-extraction direction D2. This can be adjusted by the length dimension of the parallel beam part 121b or the length dimension of the spring beam part 121c, for example.

Since this results in a state where the tip 221a2 of the electrode pad 221a is covered with the parallel beam part 121b, the reciprocal phenomenon of the signal S can be more reliably avoided.

However, as long as the signal S can be transmitted to the tip 221a2 of the electrode pad 221a in a state where the electrode pad 221a and the parallel beam part 121b are not in contact with each other, the tip 221a2 of the electrode pad 221a may be within a range on the spring beam part 121c side, for example.

Note that the shorter electrode pads 221a illustrated in FIG. 10 are pads for signal pins, and the longer electrode pads 221a are pads for ground pins.

In FIG. 9 and FIG. 10, each signal pin is labeled with reference 121(S), each ground pin is labeled with reference 121(G), the electrode pad for the signal pin is labeled with reference 221a(S), and the electrode pad for the ground pin is labeled with reference 221a(G) for reference.

The contact pin 131 is configured in the same manner, and when the substrate 221 has been inserted in the connector 100, the parallel beam part 131b is arranged substantially parallel to the electrode pad 221a.

Thus, when the substrate 221 has been inserted in the connector 100, the parallel beam part 121b of the contact pin 121 and the parallel beam part 131b of the contact pin 131 are in substantially a parallel state.

According to the present embodiment, the following advantageous effects are achieved.

Since the base end 121b1 of the parallel beam part 121b forms a bent part bent outward, the parallel beam part 121b can be located closer to the electrode pad 221a than the spring beam part 121c.

Further, since the parallel beam part 121b has a smaller inclination angle relative to the insertion-extraction direction D2 than the spring beam part 121c, the angle of the parallel beam part 121b relative to the electrode pad 221a of the substrate 221 can be smaller than the angle of the spring beam part 121c relative to the electrode pad 221a of the substrate 221 when the substrate 221 has been inserted.

Thus, the contact pin 121 can be located closer to the electrode pad 221a compared to a configuration without the parallel beam part 121b.

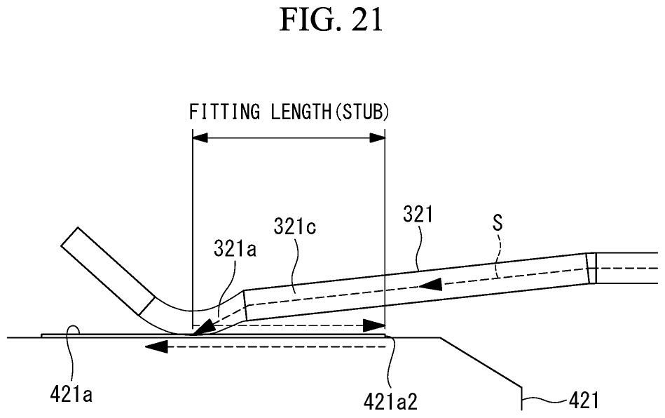

The “configuration without the parallel beam part 121b” as used herein may be, for example, a configuration in which the spring beam part 321c is directly connected to the curved part 321a as illustrated in FIG. 21, a configuration in which the inclination angle of the parallel beam part 121b and the inclination angle of the spring beam part 121c are the same and the parallel beam part 121b and the spring beam part 121c are thus continuous in substantially a single straight shape, or the like.

Accordingly, since the high-frequency signal S (for example, the signal S at a frequency of 60 GHz or higher) is directly transmitted from the parallel beam part 121b to the electrode pad 221a without routed via the contact point 121a3, the insertion loss caused by a reciprocal phenomenon of the signal S due to the fitting length (Stub) can be reduced. In other words, since the signal S can be transmitted directly from the parallel beam part 121b to the electrode pad 221a by the effect described above, a long fitting length can be ensured taking the manufacturing tolerance of the connector 100, the manufacturing tolerance of the substrate 221, or influence of the fitting tolerance into consideration.

Note that, naturally, not the entire signal S is transmitted to the electrode pad 221a without routed via the contact point 121a3.

Further, the length dimension of the parallel beam part 121b is adjusted so that, when the substrate 221 has been inserted, the tip 221a2 of the electrode pad 221a is located between the base end 121b1 and the tip 121b2 of the parallel beam part 121b in the insertion-extraction direction D2, and thereby the signal S can be more reliably transmitted from the parallel beam part 121b to the tip 221a2 of the electrode pad 221a. Thus, a reciprocal phenomenon of the signal S due to influence of Stub can be more reliably avoided.

Further, the distance (dimension) of the clearance G between the parallel beam part 121b and the electrode pad 221a when the substrate 221 has been inserted is designed to be less than or equal to 0.07 mm, and thereby the high-frequency signal S can be efficiently, directly transmitted from the parallel beam part 121b to the electrode pad 221a.

Further, with this distance being at least about 0.03 mm, the insertion loss can be suppressed as much as possible within a range where the parallel beam part 121b is not in direct contact with the electrode pad 221a.

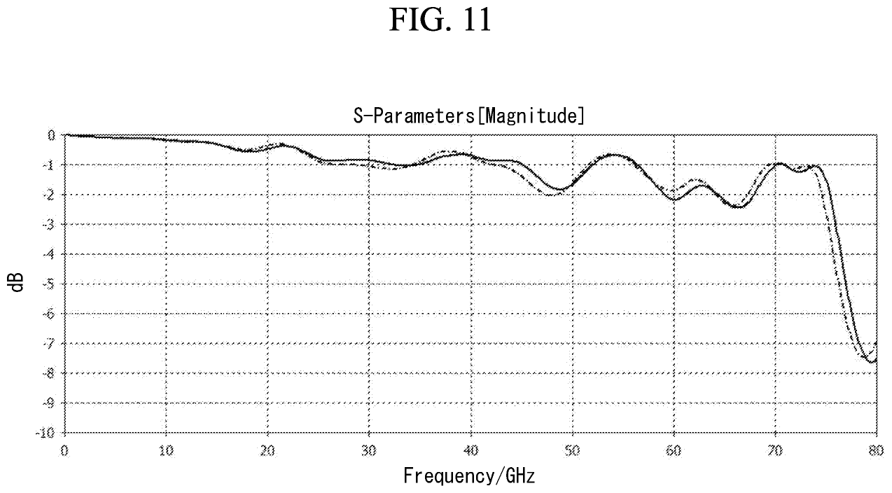

Herein, the influence on the insertion loss caused by the distance between the parallel beam part 121b and the electrode pad 221a and the fitting length will be described with reference to simulation results of FIG. 11 to FIG. 15.

Note that, in FIG. 11 to FIG. 14, each dotted line represents a case where the fitting length is 0.53 mm, and each solid line represents a case where the fitting length is 0.75 mm. Further, the frequency in comparison is about 65 GHz for each case.

FIG. 11 is a graph illustrating a relationship between the frequency (horizontal axis) and the insertion loss (vertical axis) when the distance of the clearance G is 0.03 mm.

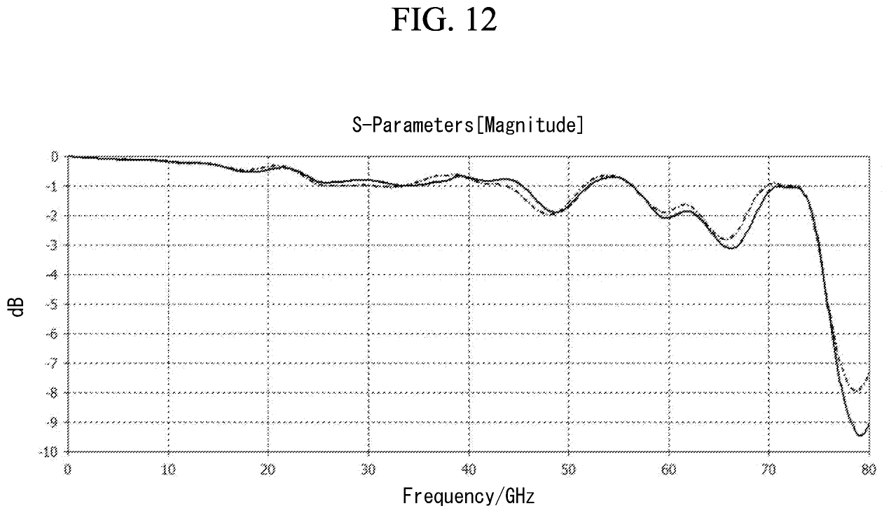

FIG. 12 is a graph illustrating a relationship between the frequency and the insertion loss when the distance of the clearance G is 0.05 mm.

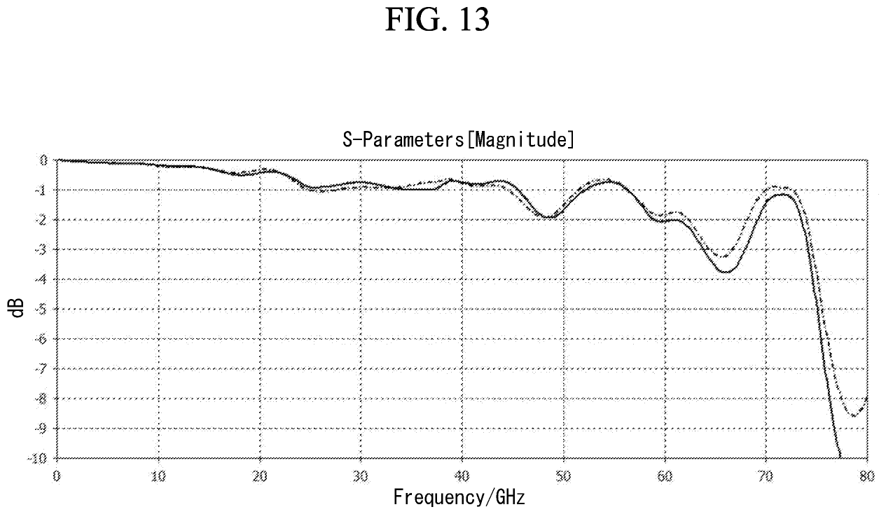

FIG. 13 is a graph illustrating a relationship between the frequency and the insertion loss when the distance of the clearance G is 0.07 mm.

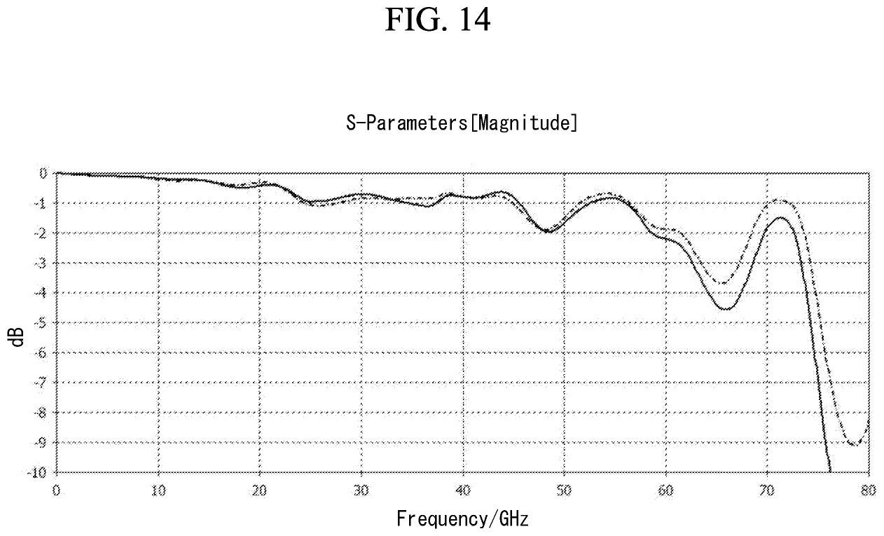

FIG. 14 is a graph illustrating a relationship between the frequency and the insertion loss when the distance of the clearance G is 0.10 mm.

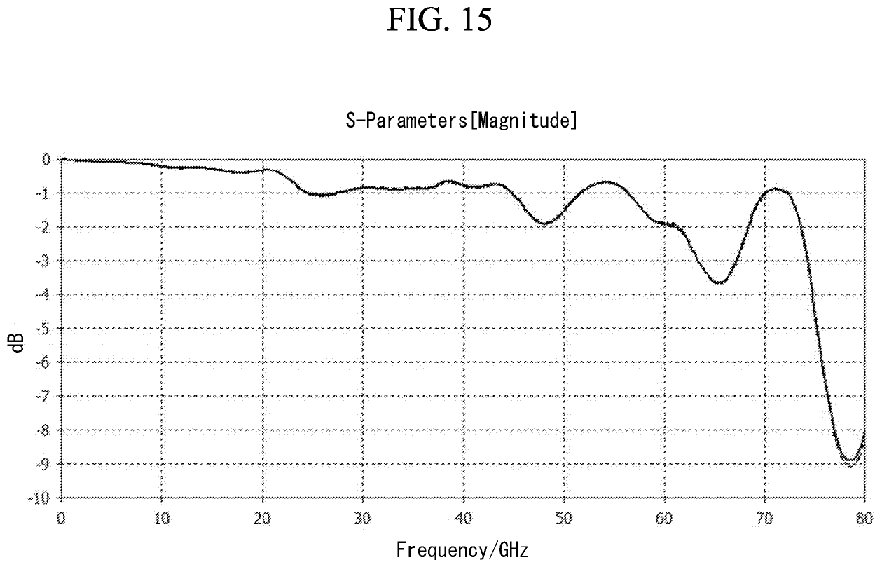

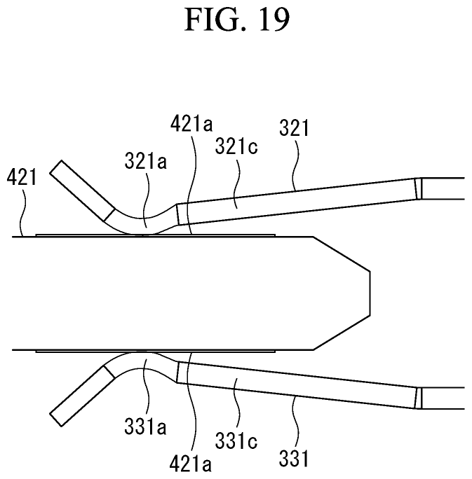

FIG. 15 is a graph as a comparative example, and the dotted line represents the insertion loss of the contact pin of the present embodiment when the distance of the clearance G is 0.10 mm, and the solid line represents the insertion loss of a general contact pin as illustrated in FIG. 19, for example. Note that the fitting length is 0.53 mm.

According to FIG. 11, when the distance of the clearance G is 0.03 mm, the difference between the insertion loss when the fitting length is 0.53 mm and the insertion loss when the fitting length is 0.75 mm (hereafter, this difference is referred to as “drop”) is about 0 (zero) dB.

According to FIG. 12, when the distance of the clearance G is 0.05 mm, the drop is about 0.3 dB.

According to FIG. 13, when the distance of the clearance G is 0.07 mm, the drop is about 0.6 dB.

According to FIG. 14, when the distance of the clearance G is 0.10 mm, the drop is about 1.0 dB.

Herein, as can be seen from FIG. 15 as the comparative example, the insertion loss of the contact pin of the present embodiment when the distance is 0.10 mm and the fitting length is 0.53 mm represented by the dotted line (which is equal to the dotted line of FIG. 14) is substantially not different from the insertion loss of the general contact pin.

As described above, (1) a shorter fitting length results in a smaller insertion loss, (2) a smaller clearance results in a smaller insertion loss, (3) a clearance of about 0.03 mm results in a drop of substantially 0 (zero), and (4) with a clearance of 0.07 mm and a fitting length of 0.75 mm, substantially the same transmission performance as the case with a clearance of mm and a fitting length of 0.53 mm can be ensured. That is, it can be found that a reduction of the insertion loss can be achieved when the clearance is less than or equal to 0.07 mm.

### Modified Example

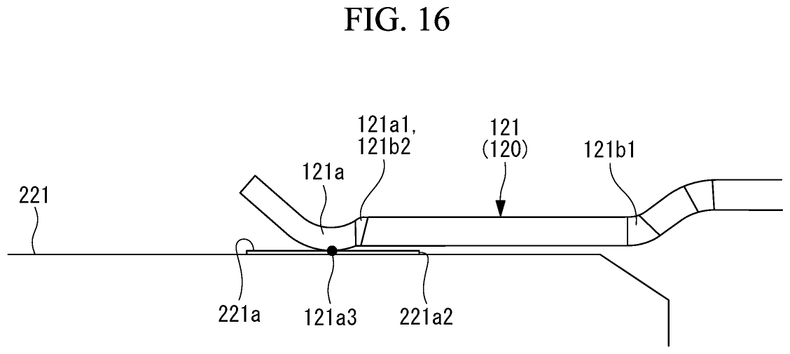

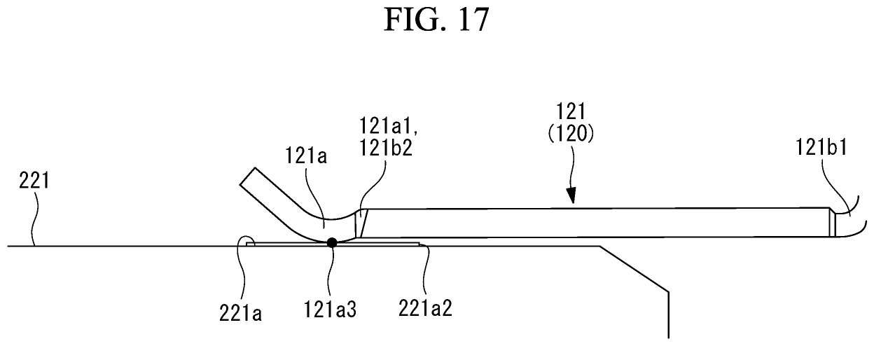

For example, the base end 121b1 of the parallel beam part 121b may be formed as with the form illustrated in FIG. 16 and FIG. 17. In both cases, the parallel beam part 121b is located close to the electrode pad 221a because of the bent base end 121b1.

### REFERENCE SIGNS LIST

100 connector
   110 housing
      111 front opening
      112 insertion space
   120 top pin group (first pin group)
      121 contact pin
         121a curved part
         121a1 base end
         121a2 tip
         121a3 contact point
         121b parallel beam part (first beam part)
         121b1 base end
         121b2 tip
         121c spring beam part (second beam part)
         121c1 base end
         121c2 tip
         121d substantially-straight part
         121d1 base end
         121d2 tip
         121e erect part
         121e1 base end
         121e2 tip
         121f mount part
         121f2 tip
   130 bottom pin group (second pin group)
      131 contact pin
         131a curved part
         131a1 base end
         131a2 tip
         131a3 contact point
         131b parallel beam part (first beam part)
         131b1 base end
         131b2 tip
         131c spring beam part (second beam part)
         131c1 base end
         131c2 tip
         131d substantially-straight part
         131d1 base end
         131d2 tip
         131e erect part
         131e1 base end
         131e2 tip
         131f mount part
         131f2 tip
   140 conductive member
210 mount substrate
221 substrate (device)
   221a electrode pad (electrode)
      221a2 electrode tip
D1 predetermined direction
D2 insertion-extraction direction

1. A connector comprising:
a first pin group having a plurality of contact pins aligned in a predetermined direction; and
a second pin group having a plurality of contact pins aligned in the predetermined direction and arranged so as to face the first pin group,
wherein a device is inserted and extracted along an insertion-extraction direction in and from a region between the first pin group and the second pin group, and
wherein each of the contact pins has
a curved part curved convex toward the region and including a contact point contacted with an electrode of the device, and
a straight first beam part having a tip and a base end, the tip of the first beam part being connected to a base end of the curved part, and the base end of the first beam part being bent so as to be spaced away from the region.

2. The connector according to claim 1,
wherein each of the contact pins has a second beam part having a tip and a base end, the tip of the second beam part being connected to the base end of the first beam part, and the base end of the second beam part serving as a fixed end for elastic deformation, and
wherein the first beam part has a smaller inclination angle relative to the insertion-extraction direction than the second beam part.

3. The connector according to claim 1, wherein the first beam part has an angle relative to the electrode that is greater than or equal to −10 degrees and less than or equal to 10 degrees with the device inserted.

4. The connector according to claim 3, wherein the first beam part is substantially parallel to the electrode with the device inserted.

5. The connector according to claim 1, wherein the first beam part has a length dimension such that, with the device inserted, a tip of the electrode is located between the base end of the first beam part and the tip of the first beam part in the insertion-extraction direction.

6. The connector according to claim 1, wherein a distance from the first beam part to the electrode is less than or equal to 0.07 mm with the device inserted.

7. The connector according to claim 6, wherein a distance from the first beam part to the electrode is greater than or equal to 0.03 mm with the device inserted.

8. A connector comprising:
a first pin group having a plurality of contact pins aligned in a predetermined direction; and
a second pin group having a plurality of contact pins aligned in the predetermined direction and arranged so as to face the first pin group,
wherein a device is inserted along an insertion-extraction direction in a region between the first pin group and the second pin group,
wherein each of the contact pins has
a curved part curved convex toward the region and including a contact point contacted with an electrode of the device,
a straight first beam part having a tip connected to a base end of the curved part, and
a second beam part having a tip and a base end, the tip of the second beam part being connected to the base end of the first beam part, and the base end of the second beam part serving as a fixed end for elastic deformation, and
wherein the first beam part of each of the contact pins of the first pin group and the first beam part of each of the contact pins of the second pin group are substantially parallel to each other with the device inserted.

9. The connector according to claim 1 further comprising a conductive member electrically connected to a ground pin for grounding out of the contact pins of the first pin group and to a ground pin for grounding out of the contact pins of the second pin group.

10. A connector comprising a plurality of contact pins, wherein a signal is transmitted from a base end to a tip of each of the contact pins, and a device having an electrode is inserted in the connector, and
wherein each of the contact pins has a contact point and a first beam part, the contact point being contacted with the electrode, and the first beam part being electrically connected to the electrode in a contactless manner on the base end side from the contact point.

11. A connector assembly comprising:
the connector according to claim 1; and
the device inserted in the connector.
